(19) United States
(12) Patent Application Publication
(10) Pub. No.: US 2013/0345093 A1
(43) Pub. Date: Dec. 26, 2013

(54) Method for Detection and Quantification of Target Biomolecules

(71) Applicants: Guillaume Legent, Bonsecours (FR); Christine Heuclin, Belbeuf (FR)

(72) Inventors: Guillaume Legent, Bonsecours (FR); Christine Heuclin, Belbeuf (FR)

(73) Assignee: BIOSIMS TECHNOLOGIES, Rouen (FR)

(21) Appl. No.: 14/003,990

(22) PCT Filed: Mar. 12, 2012
(86) PCT No.: PCT/EP2012/054278

§ 371 Date: Sep. 9, 2013

Related U.S. Application Data
(60) Provisional application No. 61/451,181, filed on Mar. 10, 2011.

(30) Foreign Application Priority Data
Mar. 10, 2011 (EP) 11305257.5

(51) Int. Cl. G01N 27/62

(52) U.S. Cl. CPC G01N 27/62
USPC 506/12

(57) ABSTRACT

The invention relates to a method for detection and quantification of target biomolecules, such as DNA, RNA or proteins, using exogenous element labelling and dynamic secondary ion mass spectrometry.

### FIELD OF THE INVENTION

The invention relates to a method for detection and quantification of target biomolecules, such as DNA, RNA or proteins, using exogenous element labelling and secondary ion mass spectrometry.

### BACKGROUND OF THE INVENTION

In the early sixties, Castaing and Slodzian developed mass-filtered emission ion microscopy using secondary ions, which is part of a technique later named secondary ion mass spectrometry (SIMS). With this technique, a beam of ions (the primary ion beam) is used as a probe to sputter the surface atomic layers of a sample into atoms or atomic clusters, a small fraction of which are ionized. In a SIMS instrument, these secondary ions are separated according to mass and are then used to measure a secondary ion current to create, for example, a quantitative atomic mass image of the analyzed surface.

SIMS has become a major tool in semiconductor and surface science studies, geochemistry, the characterization of organic material, and cosmochemistry. However, ion microscopy has been for a long time considered only as a marginal method for solving problems in life sciences, due mainly to poor lateral resolution (1-0.5 μm) and insufficient mass separation power.

There are two different kinds of SIMS techniques, the first one is the dynamic SIMS (D-SIMS), it is characterised by a continuous primary ion bombardment with a high intensity combined to a mass detector (quadripole or magnetic sector). The second SIMS technique is the static SIMS (ToF-SIMS), it is characterised by a discontinuous low intensity primary ion bombardment combined to a Time of flight detector. The main difference is the intensity of bombardment. Dynamic SIMS is a destructive techniques that transform the surface material (from the surface to few nanometres depth) into highly fragmented mono (or di-) atomic ions. It results that it is impossible to have structural information of the molecule of the sample surface but the intensity of signal is much better than with static SIMS. On the contrary, Static SIMS is a less destructive technique and only the extreme surface (few Angstroms) material is analysed and the structures of the molecule are preserved under the bombardment. It results in more information about the structure of the surface molecules but the intensity of signal is weaker than with D-SIMS.

Regarding to these characteristics, D-SIMS technique has the advantages upon ToF SIMS of a better sensitivity and allows it to analyse the whole material from a droplet deposited at the surface of a support (until 20 nm in depth)

In D-SIMS techniques, the two possible mass detectors are quadripole and magnetic sector. The first one is easy to use with a large range of detection but the mass resolution is limited to the unit of mass. The second one is much more efficient with mass resolution down to 10E-4 mass unit but it is also more delicate to use.

Technological and conceptual improvements led to significant progress in both lateral resolving power and mass resolution, in particular due to the use of a finely focused primary ion beam. SIMS microscopy has therefore become a very powerful imaging tool. For example, Lechene and al. were able using the SIMS technique to image individual stereocilia and the mechanosensory organelles of the inner cells of the cochlea (Lechene and al. Journal of Biology. 2006, 5:20).

In another experiment, they were able to study the nitrogen fixation in bacteria cultured in a ¹⁵N atmosphere. The use of SIMS technique also allowed Lechene and al. to localize, quantify and compare nitrogen fixation in single cells and subcellular structures (Lechene and al. Science 2007. 317:1563). Thus, SIMS technology is now widely used for imaging cells or tissues, and is a powerful tool for diagnostic.

SIMS technique was also used to detect hybridization of unlabelled DNA to microarrays of peptide nucleic acids (PNA) (Brandt et al, 2003, Nucleic Acids Research, 31: 19). In these experiments, PNA/DNA or PNA/RNA duplexes were visualized by SIMS detecting the phosphates that are an integral part of the nucleic acids but are completely missing in PNA.

WO2009/113044 discloses an array comprising a substantially planar substrate having a conducting surface and a number of discrete areas containing probes being labelled with at least one rare, stable or unstable isotope or exogenous isotope and a method for detecting and quantifying in at least one sample the presence or absence of at least one biomolecule, comprising: (a) contacting said at least one sample with said array, (b) washing and drying the array, (c) detecting and counting by SIMS the common secondary ions along with the corresponding rare secondary ions, (d) calculating the isotopic ratio. The specific signal for target/probe hybridisation is an increase or decrease of the isotopic ration of the same elements compared to the natural isotopic ration of this element. If the probes are labelled with a purified isotope of an exogenous element, the targets have to be labelled with another purified isotope of the same exogenous element to calculate the isotopic ratio. If the probes are unlabelled, the targets have to be labelled with a rare natural isotope to calculate the isotopic ratio.

The invention aims to provide a method for detecting and quantifying the presence or absence of a number of biomolecules in a sample using the SIMS technique.

The method described in Brandt et al. presents the following drawbacks: (i) it can only be applied with PNA probes or probes that do not contain phosphates and (ii) it does not allow quantification of the interaction probe/target.

The method described in WO2009/113044 presents the following drawbacks: (i) involvement of isotopes, (ii) not applicable to commercial arrays or to commercial probes like commercial antibodies, (iii) measure of the signal between two different isotopic forms of the same element.

Therefore, the Applicant aims to provide a universal method that can be applied to a great number of samples for the detection and the quantification of a great number of interaction probe/targets in each sample using the SIMS technique.

### SUMMARY OF THE INVENTION

The present invention relates to a method for detecting and quantifying at least one type of target molecules by quantifying molecules-molecules interactions, comprising:
(a) grafting unlabelled molecules on one or more array(s),
(b) labelling with one or more exogenous element(s) one or more type(s) of circulating molecules in one or more solution(s);
(c) putting solution(s) containing circulating molecules into contact with one or more array(s) obtained from step (a), before or after the labelling step (b), under conditions that allow the unlabelled grafted molecules present on the array(s) to interact with the circulating molecules from the solution,
(d) washing and drying the array,
(e) possibly locating the so-obtained spots
(f) detecting and counting by D-SIMS said exogenous element(s) of each labelling or a group of elements containing said exogenous element(s) of each labelling and possibly a reference natural element present on the spot for each spot of each array
(g) calculating the ratio(s) between spots of the values of the counting by D-SIMS of each labelling and/or calculating the ratio(s) for each spot between the value of the counting by D-SIMS of each labelling and the value of the counting by D-SIMS of a reference natural element present on the spot.

### DETAILED DESCRIPTION OF THE INVENTION

### Definitions

The term “sample” as used herein relates to a material or mixture of materials, typically, although not necessarily, in fluid form, containing one or more components of interest (targets).
The term “solution” as used herein relates to a fluid comprising circulating molecules (targets or probes).
The term “probe” as used herein relates to a molecule or a group of molecules that binds specifically with the target biomolecules.
The term “nucleic acid” as used herein means a polymer composed of nucleotides, e.g., deoxyribonucleotides or ribonucleotides, or compounds produced synthetically such as PNA which can hybridize with naturally occurring nucleic acids in a sequence specific manner analogous to that of two naturally occurring nucleic acids, e.g., can participate in Watson-Crick base-pairing interactions.
The terms “ribonucleic acid” and “RNA” as used herein mean a polymer composed of ribonucleotides.
The terms “deoxyribonucleic acid” and “DNA” as used herein mean a polymer composed of deoxyribonucleotides.
The term “oligonucleotide” as used herein denotes single stranded nucleotide multimers of from about 10 to 100 nucleotides and up to 200 nucleotides in length.
The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g. wherein one or more of the hydroxyl groups are replaced with halogen atoms or aliphatic groups, or are functionalized as ethers, amines, or the like.
The term “aptamer” as used herein means oligonucleic acid or peptide molecules that bind to a specific target molecule. Aptamers are usually created by selecting them from a large random sequence pool.
The term “protein” as used herein means a polymer of amino acid residues linked together by peptide bonds. The term, as used herein, refers to proteins, polypeptides, and peptides of any size, structure, or function. Typically, however, a protein will be at least six amino acids long. Preferably, if the protein is a short peptide, it will be at least about 10 amino acid residues long. A protein may be naturally occurring, recombinant, or synthetic, or any combination of these. A protein may also be just a fragment of a naturally occurring protein or peptide. A protein may be a single molecule or may be a multi-molecular complex. The term protein may also apply to amino acid polymers in which one or more amino acid residues are an artificial chemical analogue of a corresponding naturally occurring amino acid. An amino acid polymer in which one or more amino acid residues is an “unnatural” amino acid, not corresponding to any naturally occurring amino acid, is also encompassed by the use of the term “protein” herein.
The term “lectin” as used herein means a sugar-binding protein that is highly specific for its sugar moieties, e.g. a specific glycosylation.
The term “array” as used herein means a number of distinct or different spots containing grafted molecules (probes or targets) bound to the surface of a solid or semi-solid support.
The term “spots” refers to discrete areas or microwells on the surface of the array, wherein molecules (probes or targets) are grafted.
The term “grafting” refers to the action of immobilizing probes or targets by covalent or uncovalent bonds at the surface of a support, including specific capture by a molecule previously present on this support.
The term “spotting” refers to the action of grafting probes or targets on a delimited area (spot) at a known relative position in the array.
The expression “locating” the spots as used herein means using optical, spectrometric or electronic means to view the spots and/or the array.
The term “grafted molecule” as used herein relates to a molecule or a group of molecules (probe or target) that is grafted on the spots.
The term “circulating molecule” as used herein relates to a molecule or a group of molecules (target or probe) that is in the solution deposited on the arrays to interact with the grafted molecules on the spots.
The term “Forward-phase microarray” relates to an array where capture probes are spotted in order to graft targets by uncovalent bonds (e.g. immuno-capture).
The term “Reverse phase array” relates to an array where the samples to be tested are spotted on the surface, resulting in spots containing biomolecules to be tested.
The term “exogenous element” refers to those common elements that are not naturally contained in the circulating or grafted molecules (probes and targets) but that have been added to the circulating molecules by the user. This term also excludes purified or rare isotopes of elements The exogenous elements may be covalently linked to the molecules via standard chemistry or biochemistry. Alternatively, the exogenous elements may be covalently attached to a molecule that interacts itself covalently or strongly with either the probe or the target and that does not reduce significantly recognition of targets by probes. Examples of exogenous elements include: I, Br, F, S, Au, Fe, Se, As, P, B, Cu, Ag, Zn, Ni with the provision that they are not naturally contained in the circulating or grafted molecules. For example, P is not to be used with nucleic acids.
The expression “a reference natural element” as used herein means a common element present on the spot, that comes either directly from the grafted molecules or indirectly from their grafting buffer. These elements can be naturally contained in the molecules (e.g.: C, N, O, S, P) or can be added by the user in the buffer (e.g.: I, Br, F, Au, Fe, Se, As, B, Cu, Ag, Zn, Ni), either free (e.g. inorganic salt) or covalently bond to a carrier molecule (e.g. Iodinated Bovine Serum Albumin).

The Method of Detection and Quantification

One object of the invention is a method for detecting and quantifying at least one type of target molecules by quantifying molecules-molecules interactions, comprising:
(a) grafting unlabelled molecules on one or more array(s),
(b) labelling with one or more exogenous element(s) one or more type(s) of circulating molecules in one or more solution(s);
(c) putting solution(s) containing circulating molecules into contact with one or more array(s) obtained from step (a), before or after the labelling step (b), under conditions that allow the unlabelled grafted molecules present on the array(s) to interact with the circulating molecules from the solution,
(d) washing and drying the array,
(e) possibly locating the so-obtained spots,
(f) detecting and counting by D-SIMS said exogenous element(s) of each labelling or a group of elements containing said exogenous element(s) of each labelling and possibly a reference natural element present on the spot for each spot of each array.
(g) calculating the ratio(s) between spots of the values of the counting by D-SIMS of each labelling and/or calculating the ratio(s) for each spot between the value of the counting by D-SIMS of each labelling and the value of the counting by D-SIMS of a reference natural element present on the spot.

Circulating molecules and grafted molecules are probes or targets.

When circulating molecules are targets, grafted molecules are probes.

When grafted molecules are targets, circulating molecules are probes.

Circulating molecules and grafted molecules are compatible to interact.

The circulating molecules are labelled before or after being put onto the array.

The circulating molecules (targets or probes) only are labelled. Several samples or several types of molecules in one sample can be labelled with different exogenous elements. For example, two samples are assayed, one is labelled with an exogenous element X and the other is labelled with an exogenous element Y different from X. These several samples or several types of molecules are all put into contact with one array or some of them are put into contact with one array and the others are put into contact with another array. In the case of several samples or several types of molecules are all put into contact with one array, the ratio between the different exogenous elements for each spot of the array is calculated. In the case of some of them are put into contact with one array and the others are put into contact with another array, the ratio between each exogenous element and a reference element is measured for each spot of each array and the results of each array are compared for each spot.

Grafting

Direct grafting is achieved by depositing manually or automatically a drop of a buffer containing the molecules to be grafted at the surface of the support. Thanks to an appropriate surface chemistry, the drop will dry thus grafting covalently or uncovalently the molecules and delimiting the spot area. Microarray manufacturing robots will provide well organized and calibrated arrays.

Undirect grafting will be processed in two steps: a first step will consist in creating an array of capture areas either by using direct grafting of capture molecules or by using other techniques based on polymer chemistry like imprinted polymers, microstamping, self assembled polymers, and/or based on surface chemistry like nanolithography. The second step will consist in depositing the molecules to be grafted at the surface of the array resulting from the first step, and using standard hybridization procedures to let the molecules to be grafted strongly interact with the capture areas.

Labelling

According to the method of the invention, the probes or the targets, i.e. the circulating molecules present in the solution are labelled with exogenous elements.

Only circulating molecules are labelled.

Exogenous elements may be chosen in the group consisting of I, Br, F, S, Au, Fe, Se As, P, B, Cu, Ag, Zn, Ni.

Labelling can be obtained chemically or in vitro.

In the case of chemical labelling,

1) chemical reaction such as iodination or bromination can be performed using chloramine T protocols or derivatives of chloramine T protocols using polystyrene beads. Markwell, M. A. (1982). A new solid-state reagent to iodinate proteins: conditions for the efficient labeling of antiserum. Anal. Biochem. 125: 427-32.

2) Click chemistry can easily be used to join small labelled molecules with probe or target molecules in gentle conditions: e.g. PEGylation reactions are smart protocols allowing one to combine a molecule with a polyethylene glycol (PEG) arm linked to e.g. a labelled aniline (bromoaniline, iodoaniline, or any aromatic component containing exogenous elements), or to combine a molecule with a polyethylene glycol directly labelled with an exogenous element.

3) Strong interactions can be used to join labelled molecules with probe or target molecules: e.g. PEGylation allows to combine a molecule with a polyethylene glycol arm linked with a biotine. Iodinated avidine or streptavidine can then strongly interact with the biotine, either before or after the probe and target are put into contact. Manning, J., et al. (1977). A method for gene enrichment based on the avidin-biotin interaction. Application to the drosophila ribosomal RNA genes. Biochemistry 16: 1364-70.

4) Chemical synthesis is used to produce labelled PNA or aptamers.

In the case of in vitro labelling,

1) The polymerase chain reaction is used to produce labelled oligonucleotides, thanks to labelled nucleotides like e.g. labelled uridine.

2) Peptide synthesis is used to produce labelled peptides with labelled amino acid like e.g. selenocysteine,

3) In vitro transcription/translation is used to produce labelled RNA and labelled proteins,

4) Reverse transcription is used to produce labelled cDNA,

Labelling also includes indirect labelling by labelled molecules specific from the circulating molecules. Circulating molecules thus interact with the grafted molecules and these other molecules in a sandwich manner. For example, the molecules from the samples are grafted on spots onto the support, and the resulting array containing at least one spot for one sample is put in contact with a solution containing one or more circulating molecules (probes) e.g. antibodies that are specific to the sample targeted antigens. Labelled molecules, e.g. antibodies, specific from the probes are then put on the array to detect the probes.

Contact Between Sample and Array

In one embodiment of the method of the invention, the sample to be tested is put in contact with one or more arrays containing a number of spots containing grafted molecules.

In another embodiment, where a number of samples is to be tested,
all of the samples are labelled with the same exogenous element, and put in contact with one different array for each sample,

or
each sample is labelled with a different exogenous element and all the samples to be tested are put in contact with the same array.

Conditions of Interaction Between Probe and Target

The solution(s) is/are then contacted with the array under conditions that allow the grafted molecules (probes or targets) present onto the array to interact with the circulating molecules (target or probes).

The binding of probes to their targets is then performed in a variety of buffers from which, typically, the exogenous elements are absent (such as Phosphate Buffer Saline or Tris Buffer Saline). After careful washing with pure water (preferably at low temperature to limit the dissociation of probes from their targets) to eliminate salts (which can form crystals at the drying step), the unbound molecules and the big cellular debris, the array is dried in a dust-free atmosphere either in an oven under vacuum or by freeze-drying or by centrifugation.

Locating the Spots

Several methods can be used to locate the spots:
Stained buffer can conduct to coloured spots located with optical devices.
Using low density blocking buffers leads to local modifications of the light reflexion that can permit to discriminate the spot area with optical devices and leads to local modifications of the elements density that can be observed with the D-SIMS focused on common elements like carbon, oxygen, or nitrogen. Using D-SIMS focused on the reference element it is possible to view the spots and the array
Using the secondary electronic microscopy mode of the D-SIMS instrument it is possible to see a difference of surface topology between the spots and the bare support.

Detection by D-SIMS

The duplexes probe/target are detected by Dynamic Secondary Ion Mass Spectrometry (D-SIMS).

Secondary Ion Mass Spectrometry (SIMS) allows the analysis of the surface composition of inorganic and organic materials based on mass spectral analysis of secondary ions extracted from the surface of a solid sample under the impact of an energetic beam of primary ions. Molecules are fragmented by the primary ion beam in D-SIMS totally into their constituent atoms by dynamic D-SIMS.

Exogenous element(s) of each labelling or a group of elements containing said exogenous element(s) of each labelling for each spot of each array are detected and counted by D-SIMS.

An element can be detected by counting the beats corresponding to its mass or can be detected by counting the beats corresponding to its mass and the beats corresponding to elements situated before and/or after this element in the periodic table.

Preferably, an element can be detected by counting the beats corresponding to its mass and the beats corresponding to the five elements situated before and/or to the five elements situated after this element in the periodic table.

As an example, iodin can be detected by counting the beats corresponding to the 127 mass, or can be detected by counting the group including Stin, Iodin, Antimonium, Tellure and Xenon, therefore counting the beats between mass 120 and mass 130.

The method of the invention uses one or more labelling with one or more exogenous elements.

All the labellings are measured by D-SIMS.

Then, several ratios can be calculated.

When several samples or several circulating molecules are labelled, the ratios for each probe can be calculated between the values of the counting by D-SIMS of each labelling of each sample or each type of circulating molecules.

The ratios for each spot can also be calculated between the values of the counting by D-SIMS of a reference natural element present on the array and those of the labelling element(s) of each circulating molecule.

The reference natural element is present on the array because it is present in the grafted molecules or it is grafted on the array or is present around the grafted molecules due to its presence in the grafting buffer. “Natural” means that it is neither a rare isotope nor a purified isotope of an element. These elements can be naturally contained in the molecules (e.g.: C, N, O, S, P) or can be added by the user in the buffer (e.g.: I, Br, F, Au, Fe, Se, As, B, Cu, Ag, Zn, Ni), either free (e.g. inorganic salt) or covalently bond to a carrier molecule (e.g. Iodinated Bovine Serum Albumin) . . . .

For example with two samples 1 and 2 respectively labelled by two exogenous elements X and Y, the ratio X/Y and the ratios X/C and Y/C can be calculated and compared for each spot (C=carbon).

When one array is used, all the solutions containing circulating molecules are put into contact with it.

Several arrays can also be used provided that they carry the same spots. In this case, each solution can be put on one array or several solutions can be put on one array. For example with two samples 1 and 2 respectively labelled by two exogenous elements X and Y put on two different arrays, the ratios X/C and X/Y can be calculated and compared for each spot.

One preferred method according to the invention for two solutions containing circulating molecules, comprises the following steps in this order:
(a) grafting unlabelled molecules on one or more array(s),
(b1) labelling with an exogenous element X at least a type of circulating molecules in a solution 1;
(b2) labelling with an exogenous element Y different from X at least a type of circulating molecules in a solution 2 different from 1;
(c) putting said solutions 1 and 2 into contact with an array under conditions that allow the unlabelled grafted molecules present on the array to interact with the circulating molecules,
(d) washing and drying the array
(e) locating the so-obtained spots,
(f) detecting and counting by D-SIMS said exogenous elements X or a group of elements containing X and Y or a group of elements containing Y and a reference natural element present on the spot for each spot of each array.
(g) calculating the ratio(s) for each spot between the values of the counting by D-SIMS
   of labellings X and Y of solutions 1 and 2, and/or
   of the reference natural element present on the spot and the labelling X of solution 1, and/or
   of the reference natural element present on the spot and the labelling Y of solution 2.

One preferred method according to the invention for detecting and quantifying in at least one solution at least one type of circulating molecules, comprises the following steps in this order:
(a) grafting unlabelled molecules on one or more array(s),
(b1) labelling with an exogenous element X at least a type of circulating molecules in a part of a solution 1;
(b2) labelling with an exogenous element Y different from X the same type of circulating molecules in a part of a solution 2 different from 1;
(c1) putting said X-labelled solution 1 and Y-labelled solution 2 into contact with an array 3 under conditions that allow the unlabelled grafted molecules present on the array to interact with the circulating molecules,
(b3) labelling with an exogenous element Y at least a type of circulating molecules in a part of solution 1;
(b4) labelling with an exogenous element X the same type of circulating molecules in a part of solution 2;
(c2) putting said Y-labelled solution 1 and X-labelled solution 2 into contact with an array 4 identical with array 3 under conditions that allow the unlabelled grafted molecules present on the array to interact with the circulating molecules,
(d) washing and drying the arrays 3 and 4
(e) locating the so-obtained spots,
(f1) detecting and counting by D-SIMS said exogenous elements X or a group of elements containing X and Y or a group of elements containing Y for each spot of the array 3
(f2) detecting and counting by D-SIMS said exogenous elements X or a group of elements containing X and Y or a group of elements containing Y for each sport of the array 4
(g1) calculating the ratios X/Y for each spot between the values of the counting by D-SIMS of labellings X and Y for array 3
(g2) calculating the ratios X/Y for each spot between the values of the counting by D-SIMS of labellings X and Y for array 4
(h) comparing for each spot the results of the ratios obtained in steps (g1) and (g2).

One preferred method according to the invention in two solutions of at least one type of molecules, comprises the following steps in this order:
(a) grafting unlabelled molecules on one or more array(s),
(b1) labelling with an exogenous element X at least a type of molecules in a solution 1;
(b2) labelling with an exogenous element Y different from X the same type of molecules in a solution 1;
(c1) putting said X-labelled solution 1 and Y-labelled solution 1 into contact with an array 3 under conditions that allow the unlabelled grafted molecules present on the array to interact with the circulating molecules,
(b3) labelling with an exogenous element Y at least a type of molecules in a solution 2;
(c2) putting said X-labelled solution 1 and Y-labelled solution 2 into contact with an array 4 identical with array 3 under conditions that allow the unlabelled grafted molecules present on the array to interact with the circulating molecules,
(d) washing and drying the arrays 3 and 4,
(e) locating the so-obtained spots,
(f1) detecting and counting by D-SIMS said exogenous elements X or a group of elements containing X and Y or a group of elements containing Y for each spot of the array 3,
(f2) detecting and counting by D-SIMS said exogenous elements X or a group of elements containing X and Y or a group of elements containing Y for each spot of the array 4,
(g1) calculating the ratios X/Y for each spot between the values of the counting by D-SIMS of labellings X and Y for array 3
(g2) calculating the ratios X/Y for each spot between the values of the counting by D-SIMS of labellings X and Y for array 4
(h) comparing for each spot the results of the ratios obtained in steps (g1) and (g2).

One preferred method according to the invention for detecting at least one post-translational modification in a protein comprises the following steps in this order:
(a) grafting unlabelled molecules on one or more array(s),
(b1) labelling with an exogenous element X proteins in a sampled solution 1;
(b2) labelling with an exogenous element Y different from X proteins in a sampled solution 1;
(c1) putting said X-labelled solution 1 and Y-labelled solution 1 into contact with an array 3 under conditions that allow the unlabelled grafted molecules present on the array to interact with the target proteins,
(c′1) putting into contact with array 3 an antibody or a lectin specific to the post-translational modification to be detected, said antibody or lectin being labelled with an exogenous element Z
(b3) labelling with an exogenous element Y proteins in a solution 2;
(c2) putting said X-labelled solution 1 and Y-labelled solution 2 into contact with an array 4 identical with array 3 under conditions that allow the unlabelled grafted molecules present on the array to interact with the target proteins,
(c′2) putting into contact with array 4 an antibody or lectin specific to the post-translational modification to be detected, said antibody or lectin being labelled with an exogenous element Z
(d) washing and drying the arrays 3 and 4
(e) locating the so-obtained spots,
(f1) detecting and counting by D-SIMS said exogenous element X or a group of elements containing X and Y or a group of elements containing Y and Z or a group of elements containing Z for each spot of the array 3
(f2) detecting and counting by D-SIMS said exogenous elements X or a group of elements containing X and Y or a group of elements containing Y and Z or a group of elements containing Z for each spot of the array 4
(g1) calculating the ratios X/Y, X/Z and Y/Z for each spot between the values of the counting by D-SIMS of labellings X, Y and Z for array 3
(g2) calculating the ratios X/Y, X/Z and Y/Z for each spot between the values of the counting by D-SIMS of labellings X, Y and Z for array 4
(h) comparing for each spot the results of the ratios obtained in steps (g1) and (g2).

One preferred method according to the invention for several solutions using several circulating probes (e.g. three probes) comprises in this order:
(a) grafting unlabelled molecules on one or more array(s),
(b1) labelling with an exogenous element X at least a type of circulating molecules
(b2) labelling with an exogenous element Y different from X another type of circulating molecules
(b3) labelling with an exogenous element Z different from X and Y another type of circulating molecules
(c1) putting said X-labelled, Y-labelled and Z-labelled circulating molecules in a solution
(c2) putting said X, Y and Z labelled probes solutions into contact with an array made of sampled molecules grafted on the support on spots, at least one spot for each sample to be tested, under conditions that allow the unlabelled sampled molecules grafted on the array to interact with the circulating labelled probes,
(d) washing and drying the array,
(e) locating the so-obtained spots,
(f) detecting and counting by D-SIMS said exogenous elements X or a group of elements containing X and said exogenous element Y or a group of elements containing Y and said exogenous element Z or a group of elements containing Z on the array
(g) calculating the ratios X/Y, X/Z and Y/Z for each spot between the values of the counting by D-SIMS of labellings X, Y and Z.

In one preferred embodiment, the circulating molecules are labelled before or after being put onto the array by an exogenous element selected in the group consisting of I, Br, F.

In one preferred embodiment, the reference element is S or C or N.

In one preferred embodiment, the circulating molecules are labelled by F before or after being put onto the array and the reference element is I or Br or the circulating molecules are labelled by I before or after being put onto the array and the reference element is F or Br.

Nature of Supporting Material and Surface

Arrays used according to the invention comprise a substantially planar support possibly having a conducting surface and a number of spots, which may or may not be in the form of wells, containing probes

According to the invention, a substantially planar support not having a conducting surface is glass or polymer material that can be coated with a conducting metal like gold, silver, aluminium, copper, platinum, before or after the spotting of the grafted molecules.

According to the invention, a substantially planar support having a conducting surface is a silicon wafer or any other solid or semi-solid surface made of gold, silver, aluminum, copper, platinum, palladium or other metal, or semiconductors such as GaAs, InP, or other material treated to make the surface conducting e.g. polymer material, polymer-coated material, superconducting material, ceramics, metal oxides, silicon oxide, etc. In one embodiment of the invention, said substantially planar substrate having a conducting surface is compatible with D-SIMS.

In a preferred embodiment of the invention, said D-SIMS-compatible substantially planar support having a conducting surface is a silicon wafer.

In one embodiment, arrays used according to the invention are microwell arrays, wherein the spots are microwells that contain grafted molecules.

Microwells may be of any shape: for example cylindrical, non-cylindrical such as a polyhedron with multiple faces (a parallelepiped, hexagonal column, octagonal column), an inverted cone, an inverted pyramid, or combining two or more of these shapes.

In another embodiment, arrays involved according to the invention are discrete areas arrays wherein the spots are discrete areas that contain grafted molecules.

The spots may have any shape, for example dots, lines, circles, squares or triangles, and may be arranged in any larger pattern, for example rows and columns, lattices, grids etc. Said arrays comprise for example from 10 to 100000 spots, preferably from 10 to 25000 spots, more preferably from 20 to 5000 spot.

Preferably, each spot has one of the dimensions length, width or diameter in the range from 1 μm to 1000 μm, more preferably from 10 μm to 100 μm.

Preferably, the distance between each spot may be from 25 to 5000 μm, more preferably from 50 to 200 μm.

Preferably, the support carrying the set of spots may be shaped as a rectangular solid or a disc (although other shapes are possible), having a diameter or a diagonal of 1 cm, and a thickness between 250 μm and 1000 μm.

Probes

Probes, which bind to targets (usually the biomolecules that constitute cells but even viruses, organelles or cells themselves), may be made of any molecules (biological or non-biological) such as nucleic acids (oligonucleotides, DNA, RNA, PNA, aptamers), peptides or proteins (antibodies, enzymes), ligands (an antigen, enzyme substrate, receptor or ligand for the receptor), glycans, lectins, lipids, polyamines, phages, viruses, or combination of these molecules.

In the case in which a diversity of different probes is attached to the array, the probes are identified via the position or coordinates of the spot containing the probes.

Surface Chemistry

The attachment of molecules to the array is achieved by techniques well-known in the art. The molecules may be adsorbed, physisorbed, chemisorbed, or covalently attached to the arrays. Lithography printing may also be used to allow molecules to be transferred and adsorbed directly or indirectly to surfaces in a patterned fashion. For example, attachment of molecules may be achieved by introducing functional groups onto the surface for chemical reaction between the surface and the molecule to be grafted. The carboxyl group (COOH) is one of the best-known functional groups for grafting. Chemical bonds are produced between amino-groups from proteins and carboxyl functional groups. Acrylic acid or copolymerised vinylsilane and maleic anhydride acid can also be used to generate silicon-COOH substrates that act as spacers to graft proteins onto the surface using e.g. 1-ethyl-3-(3-dimethylaminopropyl) carbodiimide hydrochloride. For another example, attachement of molecules may be achieved by introducing NHS group. NHS is used to prepare amine-reactive esters of carboxylate groups for chemical labelling, crosslinking and solid-phase immobilization applications. Carboxylates (—COOH) may be reacted to NHS in the presence of a carbodiimide, resulting in a semi-stable NHS ester, which may then be reacted with primary amines (—NH2) to form amide crosslinks.

Un-covalent attachment of molecules can be performed on highly hydrophobic surfaces. This kind of surfaces is achieved using the hydrophobicity properties of long aliphatic chains.

Un-covalent attachment can also be performed using electrostatic surfaces like polyamine surfaces (e.g. poly L-lysine).

Trapping of molecules on the surface is another possibility that can be performed thanks to high adsorption capacities of polymers like nitrocellulose.

Samples and Target Biomolecules

According to the method of the invention, the sample to be tested may be isolated from cells, tissue, organ, body fluid such as for instance sera, plasma, seminal fluid, synovial fluid, cerebrospinal fluid, blood or urine, a cell culture, a cell lysate, water such as sewage water, freshwater, marine coastal water, ground water or any solution containing biomolecules.

According to the method of the invention, the biomolecules to be tested may comprise nucleic acids (oligonucleotides, DNA, RNA, PNA, aptamers), peptides or proteins (antibodies, enzymes), lectins, ligands (an antigen, enzyme substrate, receptor or ligand for the receptor), glycans, lipids, polyamines, phages, viruses or a combination thereof. Thus the biomolecules to be detected may be nucleic acids (oligonucleotides, DNA, RNA, PNA, aptamers), peptides or proteins (antibodies, enzymes, prions), lectins, ligands (an antigen, enzyme substrate, receptor or ligand for the receptor), glycans, lipids, polyamines, phages, viruses or a combination thereof.

In the case in which a diversity of different samples is attached to the array, the samples are identified via the position or coordinates of the spots containing the target biomolecules.

Kits

Another object of the invention relates to a kit of diagnosis comprising a combination of array(s), probes and exogenous elements suitable for carrying out the method according to the invention as defined above.

Another object of the invention relates to a kit for proteomic or genomic research, comprising a combination of array(s), probes and exogenous elements suitable for carrying out the method according to the invention as defined above

### APPLICATIONS OF THE INVENTION

Application to Molecular Atlas

In one embodiment of the invention, the method of the invention is intended for providing a molecular atlas of said sample.

Preferably, the diversity of biomolecules to be detected and quantified is proteins, allowing the determination of proteomic variation in said sample.

The biomolecules to be detected and quantified are chosen in the group consisting of:
RNA, allowing the determination of the transcriptome of said sample,
proteins, allowing the determination of the proteome of said sample,
lipids, allowing the determination of the lipidome of said sample,
metabolites, allowing the determination of the metabolome of said sample,
glycosylated proteins, allowing the determination of the glycome of said sample, or proteins that interact with at least one specific probe, allowing the determination of the interactome of said sample.
Phosphorylated proteins, allowing for example the determination of the activation status of cell signalling proteins.

Application to Biomarkers Signatures Identification

Another object of the invention is the use of said method for detecting and quantifying at least one supposed biomarker in a number of samples for identifying a specific signature of a disease, or for identifying a specific signature of a treatment activity.

In a preferred embodiment, target biomolecules extracted from the samples are grafted on spots onto the array, with at least one different spot for each sample. A solution containing the circulating probe(s), each probe labelled with a different exogenous element, is put in contact with the target biomolecules array, allowing one to determine the quantity of the supposed biomarker(s) in each sample.

Application to Disease

Another object of the invention is the use of said method for detecting and quantifying at least one biomolecule in a sample for:—predicting a predisposition to a disease, or for diagnosing a disease in a subject, screening therapeutic agents, monitoring the efficacy of a therapeutic agent administrated to a subject in order to treat a disease.

In one embodiment, the subject is a mammal. In a preferred embodiment, the subject is a human being.

According to the method of the invention, the sample to be tested may be isolated from cells, tissue, organ, or body fluid such as for instance sera, plasma, seminal fluid, synovial fluid, cerebrospinal fluid, blood or urine, from the subject.

The sample may be derived from diseased cells or tissues. For example, the cells or tissues may be infected by a pathogen such as HIV, influenza, malaria, hepatitis, cytomegalovirus, herpes simplex virus. In one embodiment, the cells or tissues are infected by a viral or a bacterial pathogen. In another embodiment, the disease is cancer. In another embodiment, the disease is a neurodegenerative disease such as Parkinson, Alzheimer or Multiple Sclerosis. In one embodiment of the invention, said method is intended to predict a predisposition to a cancer, or for diagnosing a cancer in a subject. In another embodiment of the invention, said method is intended to predict a predisposition or to diagnose a bacterial disease.

In another embodiment of the invention, said method is intended to predict a predisposition or to diagnose a viral disease.

### FIGURES

FIG. 1: schematic assay of example 1

FIG. 2: Labelling signal depending on the labelled circulating molecules concentration

FIG. 3: schematic assay of example 2

FIG. 4: 2 labelling signals depending on the labelled circulating molecules concentration

FIG. 5: Ratio between 2 labelling signals

FIG. 6: schematic assay of example 3

FIG. 7: Ratio between 2 labelling signals

FIG. 8: Imaged results of the forward phase microarray of example 4

FIG. 9: Imaged results of the reverse phase microarray of example 5

FIG. 10: Signal vs. IgC concentration (example 5)

FIG. 11: Imaged results of the forward phase microarray of example 6

### EXAMPLES

In the following description, all experiments for which no detailed protocol is given are performed according to standard protocol.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

All these experiments were done with I-labeled peroxidase and Br-labeled peroxidase obtained by a classical protocol of iodination or bromination of proteins with Chloramine T (Sigma-Aldrich). Peroxydase was a type II peroxidase from horseradish (Sigma-Aldrich) that interacted with an anti-fucose antibody (Agrisera) which is specific for the N-glycan of plant proteins.

### Example 1

### Quantification with Iodine Label

Aim:

The aim was to show the variation of iodine signal when a grafted antibody recognized its target biomolecule labelled with iodine.

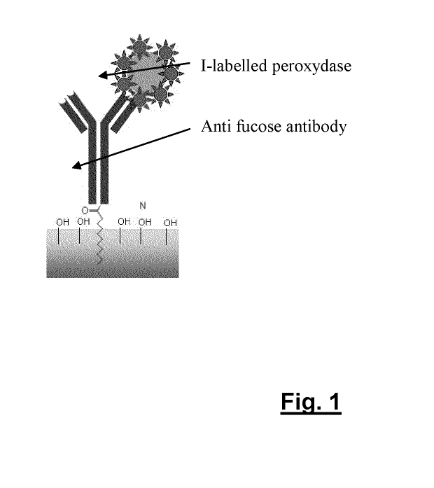

4 identical arrays were proposed with unlabelled anti fucose antibody (100 ng per deposit) and a spot of 25 ng of 1-labelled molecules in order to have a signal of reference and to indicate the ratio of target biomolecules lost during the washing of the array. Each array was incubated with an I-labelled peroxydase produced in horseradish of different concentration (from 25 ng/ml to 25 pg/ml). A blocking buffer composed essentially by BSA was added to the sample to avoid non-specific absorption. The array was washed 2 times with PBS buffer 0.1M and 2 times with pure water (5 min). The arrays were dried and analyzed with a CAMECA nanoSIMS 50 (see FIG. 1).

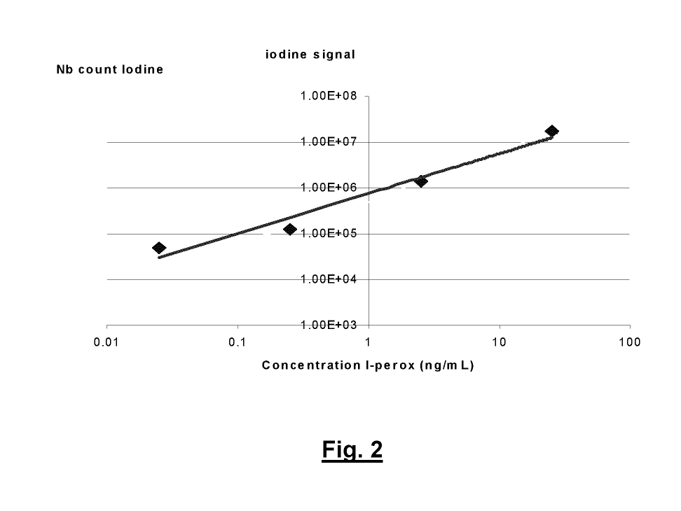

Results: see FIG. 2

We noticed a quantity-dependent signal: the variations of signal were significantly different for each concentration.

Conclusion:

Sims analysis permitted to define a new method for relative quantification of I-labelled biomolecules. These prototypes permitted to establish a calibration specific for I-labelled peroxydase.

### Example 2

### Comparison Between Iodine Labelling and Bromine Labelling

Aim:

The aim was to show the variation of iodine and bromine signals when a circulating molecule recognizes a grafted molecule. Spots of antibodies of different concentrations were made to mimic the variation of biomolecules concentrations in a biological samples. The concentration in the solutions of labelled peroxydase was calculated in order to saturate the antibodies recognition sites.

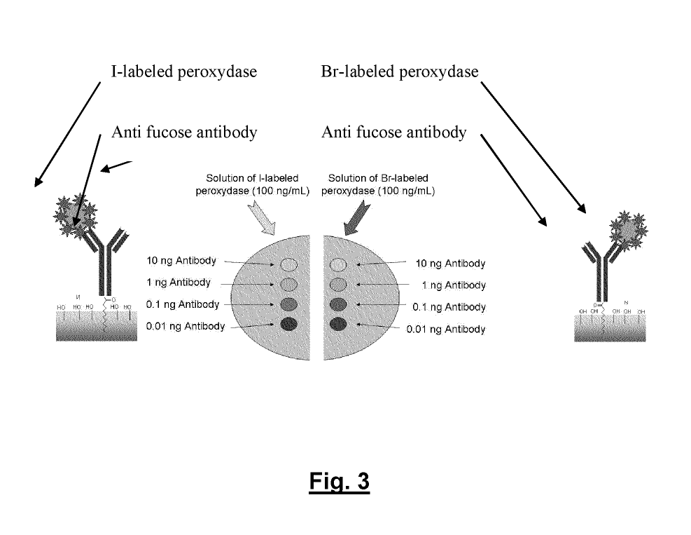

Two identical arrays were prepared with 4 concentrations (diluted with BSA) of unlabelled antibody anti fucose (10 ng to 0.01 ng per deposit). The first array was incubated with an I-labelled peroxydase produced in horseradish of 100 ng/mL of concentration and the second array with a Br-labelled peroxydase produced in horseradish of 100 ng/mL of concentration. A blocking buffer composed essentially by BSA was added to the sample to avoid non-specific absorption. The array was washed 2 times with PBS buffer 0.1M and 2 times with pure water (5 min). The array was dried and analyzed with a CAMECA nanoSIMS 50 (see FIG. 3).

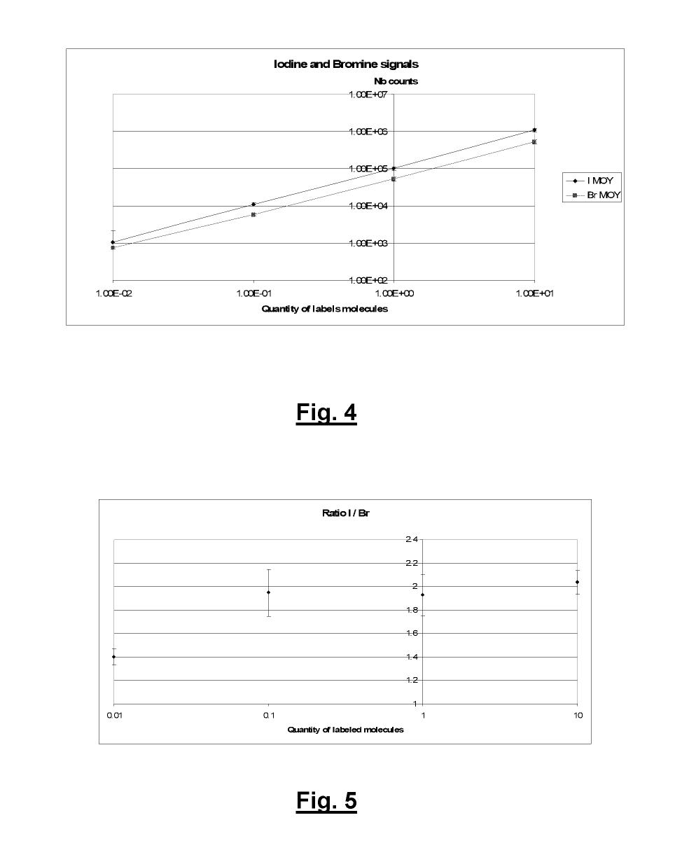

Results: FIG. 4 and FIG. 5

The signal is well correlated to the concentration of the antibody. The standard deviation is very tight for all the measurements, indicating that the signal is well reproductive (see FIG. 4).

Ratio between Iodine and Bromine signal (I/Br) was close to 2 for the quantities between 0.1 to 10 ng of antibody. For the lower quantities, the signal ratio was lower, due to a signal close to the background signal (see FIG. 5).

Conclusion:

The methods wherein the ratios between two different labels are used enhance the quality of the concentration measures.

### Example 3

### Comparison Between Iodine Labeled Peroxydase and Bromine Labeled Peroxydase on the Same Array

Aim:

The aim was to determine on the same array the variation of iodine and bromine signals when a grafted antibody recognizes its target molecule with two different labels. 3 were made identical arrays with spots of antibodies of the same concentration. The sample solutions were a combination of two samples, resulting in 3 solutions made with 3 different ratios of I-labelled peroxydase and Br-labeled peroxydase. The total concentration of peroxidase was calculated in order to saturate the antibody recognition sites.

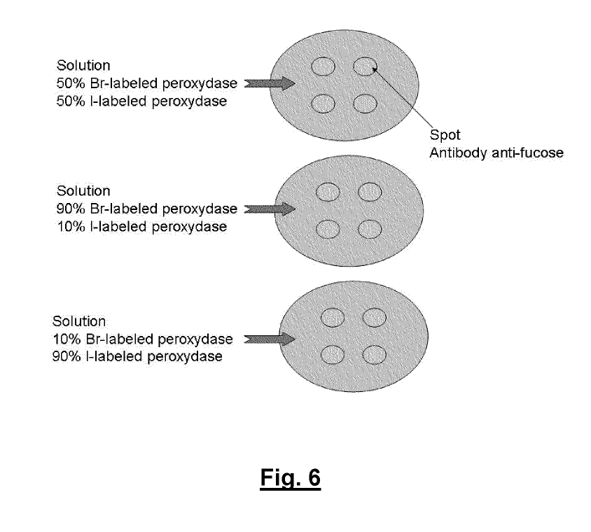

The first array was incubated with a 50% I-labelled peroxydase/50% Br-labelled peroxydase of 100 ng/mL total concentration. The second array was incubated with a 10% I-labelled peroxydase/90% Br-labelled peroxydase of 100 ng/mL total concentration. The last array was incubated with a 90% I-labeled peroxydase/10% Br-labelled peroxydase of 100 ng/mL total concentration. A blocking buffer composed essentially by BSA was added to the sample to avoid non-specific absorption. The arrays were washed 2 times with PBS buffer 0.1M and 2 times with pure water (5 min). The arrays were dried and analyzed with a CAMECA nanoSIMS 50 Isotopic ratio mode (I/Br) (see FIG. 6).

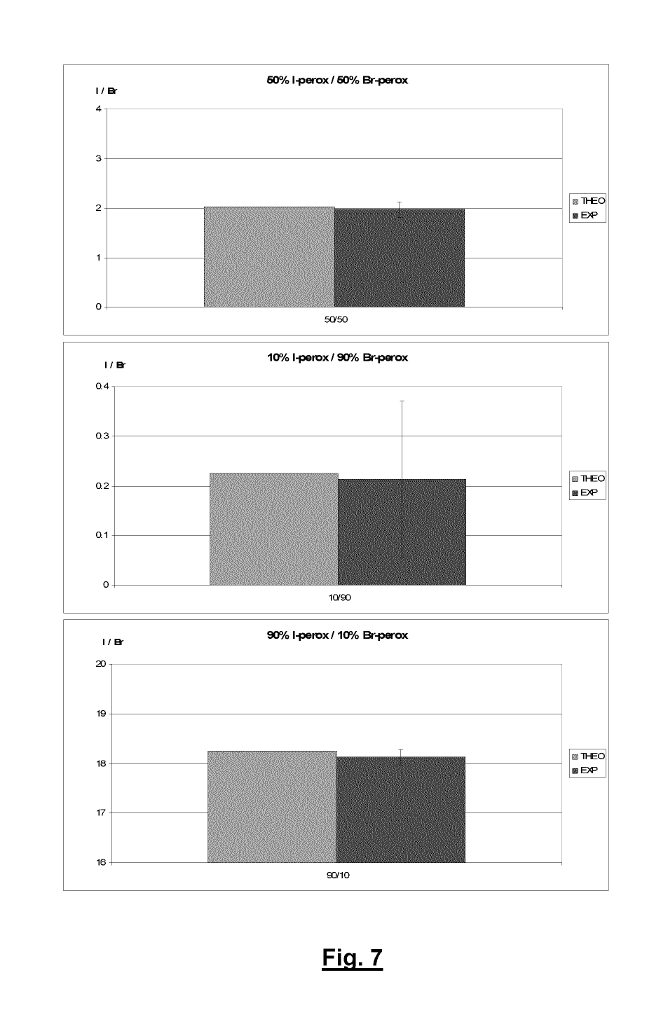

Results: see FIG. 7

For these three experiments, there is a good correlation between experimental results and theoretical results. There is no interaction between I-labeled and Br-labeled molecules that can modify the reliability of the results.

Conclusion:

The same array can be used with different labels without interaction between them. However, to limit the standard deviation, it is better to make the experiment mirrored because the standard deviation is less influent with high value of the ratio (example 3) than low value (example 2).

### Example 4

### Forward-Phase Microarray

Aim:

The aim was to perform a Forward-phase microarray with four different capture antibodies previously grafted to the support. The target molecules were directly labeled and detected by D-SIMS.

In this example, all the proteins in the sample (a serum from mouse) are labeled with fluorine as exogenous element.

An array is prepared using a Spotbot 3 microarrayer (Array'it) with 18 spots corresponding to 4 different antibodies in triplicate and 2 controls in triplicate (unlabeled BSA as a negative control, labeled BSA as a positive control). Each spot correspond to a specific capture antibody or a specific control protein.

The sample is put into contact with the array under conditions that allow the unlabeled grafted antibodies present on the spots to interact with the circulating molecules (protein targets) from the sample.

The four grafted antibodies were:
1. An antibody from rabbit against A, a protein known to be in high abundance in mouse serum
2. An antibody from goat against B, a circulating antibody known to be present in high abundance in mouse serum
3. An antibody from rabbit against C, a signaling molecule of the immune system (known to be in low concentration in the serum)
4. An antibody from rabbit against D, a cell surface protein (known to be absent from the serum).

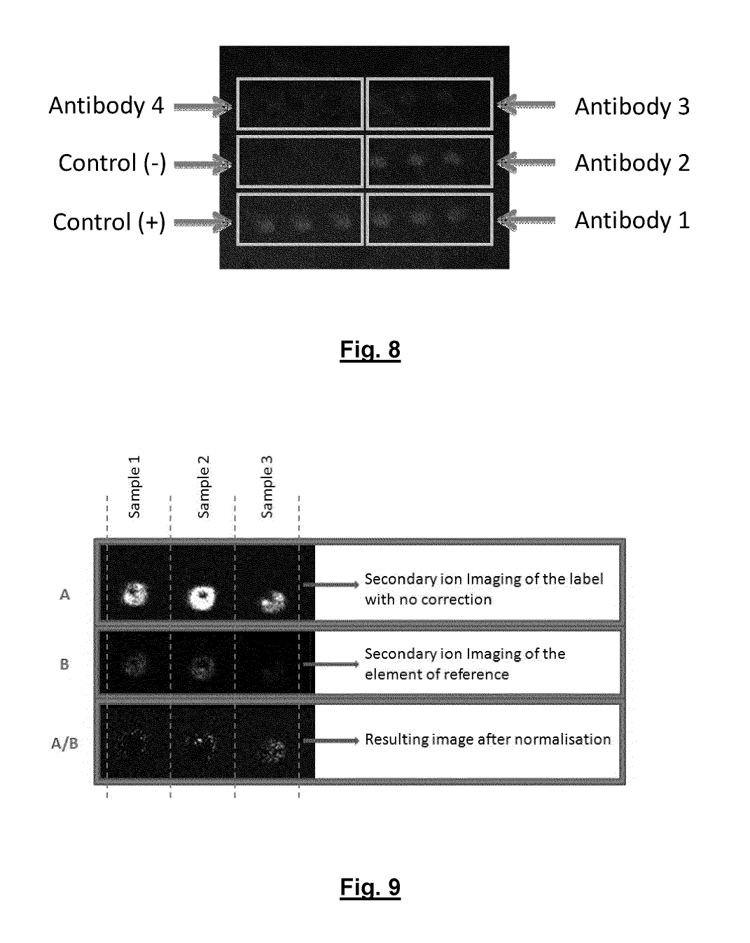

The array was washed and dried. The analysis was performed by a Dynamic SIMS (Hiden Maxim workstation) by scanning the whole array and collecting the number of beats of the exogenous element 19F for each spot of the array. FIG. 8 shows the imaged result of fluorine distribution on the array.

The spots corresponding to Antibodies 1, 2, 3 against A, B, and C emit a positive signal whether the antibody 4 against D stays negative. The signal corresponding to the positive control is positive, the signal against the negative control is negative.

The freeware program Image J was used to decipher the resulting image and determine the spots limits. It allowed to sum the wholenumber of fluorine beats from each spot.

See the below Table 1:

| Target | Spot 1 | Spot 2 | Spot 3 | Mean | Std Dev |
|---|---|---|---|---|---|
| Control (+) | 119.1 | 117.04 | 116.89 | 117.68 | 1.23 |
| Control (−) | 60.01 | 60.3 | 59.8 | 60.04 | 0.25 |
| Antibody 4 | 63.5 | 57.41 | 51.8 | 57.57 | 5.85 |
| Antibody 3 | 70 | 65.83 | 60.24 | 65.36 | 4.90 |
| Antibody 2 | 101.41 | 98.83 | 95.06 | 98.43 | 3.19 |
| Antibody 1 | 119.17 | 112.29 | 100.2 | 110.55 | 9.60 |

Conclusion:

This example validates the concept of Forward-phase microarray with exogenous labeling and dynamic SIMS quantification. Many protein/protein interactions can be observed on a same array.

### Example 5

### Reverse Phase Microarray; Normalization by a Reference Element from the Printing Buffer

Aim:

One known limit of quantifying with microarrays is the lack of repeatability and the variation of signal for two identical samples due to spotting variations. Normalization of this signal increases the reliability of the result. The aim of this example was to demonstrate how to normalize with a reference element from the buffer.

Method:

The target is a mouse IgG.

A printing buffer is prepared with standard PBS and a BSA (Bovine Serum Albumin) protein covalently bound with iodine (10 ng/mL of BSA). The target is diluted into the printing buffer in order to make a range:

Sample 1: IgG 50 ng/mL

Sample 2: IgG 75 ng/mL

Sample 3: IgG 100 ng/mL

In order to show the ability to normalize, each sample is diluted in a neuroblastoma protein extract (naturally free of IgG):

Sample 1′ is sample 1 diluted by 20:100

Sample 2′ is sample 2 diluted by 25:100

Sample 3′ is sample 3 diluted by 8:100.

A a result, sample 2′ will still have the same ratio IgG/BSA than sample 2, but it will be more concentrated than sample 3′, whether sample 2 is less concentrated than sample 3.

An array of 3 spots is prepared using a SpotBot3 microarrayer (Array'it).

Sample 1′ (control) is spotted on spot 1, sample 2′ is spotted on spot 2 and sample 3′ is spotted on spot 3.

This array is put in contact with a solution containing an antibody from goat against the constant fraction of the mouse IgG (GAM), labeled with an exogenous element (fluorine).

The analysis is done with a benchtop D-SIMS (MiniSIMS, SAI-Millbrook), by collecting the signals for the masses 19 (fluorine) and 127 (Iodine).

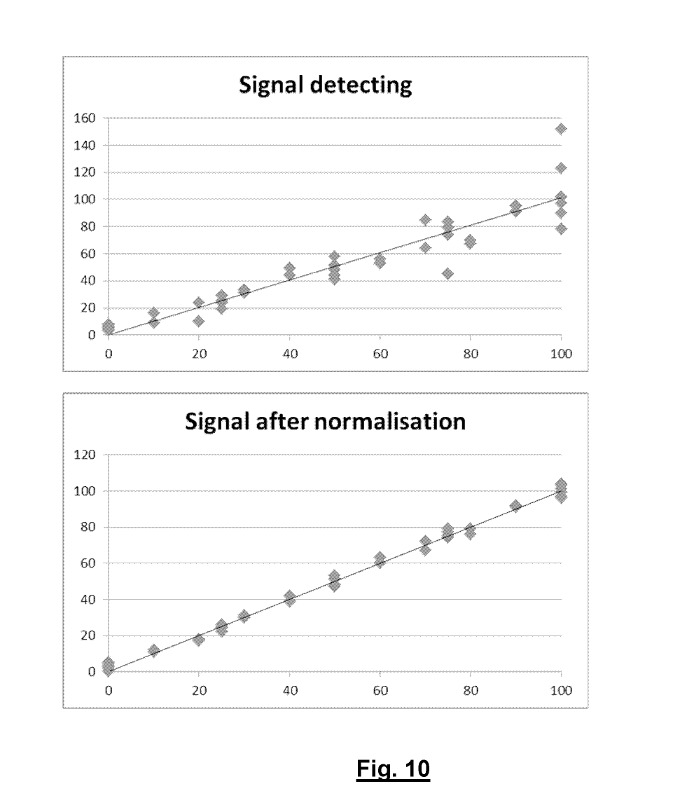

The imaged results are shown in FIG. 9.

As the quantity of IgG is more important in sample 2′ than in sample 3′, the fluorine signal (A) for spot 2 appears much more important than the fluorine signal (A) for spot 3.

Table 2 shows the quantitative results before and after normalization.

The sample 1 is used as reference; it is kept to 100%.

Using the ratio A/B were A is the signal for the label (fluorine) and B the signal for normalization (Iodine), the results are reliable: Sample 2 is showed to be 1.5 times more concentrated than sample 1 and sample 3 is 2 times more concentrated than sample 3.

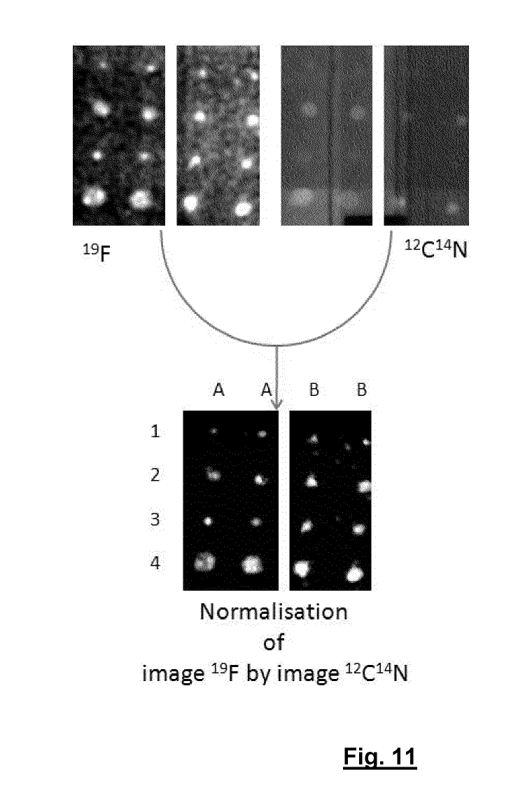

The experiment was repeated with different dilutions of the IgG in the neuroblastoma protein extract. We can see in FIG. 10, the results before and after normalization. The X-axis represents the concentration of IgG in ng/mL and the Y-axis is the signal in percent (in this second part of the example 100% represents 100 ng/mL).

TABLE 2

| | Spot 1 | Spot 2 | Spot 3 | Signal |
|---|---|---|---|---|
| A | 105 | 189 | 74 | Mean per pixel of the |
| | | | | Counts per Second |
| | | | | (Signal for Fluorine) |
| B | 21 | 24 | 7 | Mean per pixel of the |
| | | | | Counts per Second |
| | | | | (Signal for Iodine) |
| A/B | 5 | 7.9 | 10.6 | Signal of each sample |
| | | | | after normalization |
| Experimental | 50 ng/ | 79 ng/ | 106 ng/ | |
| Concentration | ml* | mL | mL | |
| detected | | | | |
| theoretical | 50 ng/ | 75 ng/ | 100 ng/ | |
| Concentration | mL | mL | mL | |
| of the target | | | | |

*The sample 1 is used as a reference sample to calculate the experimental concentration

### Example 6

### Forward Phase Microarray; Normalization by a Reference Element from the Grafted Molecules

Aim:

Normalization by an element from the grafted molecules, allows to increase the reliability of the result. The aim of this example is to demonstrate how to normalize with a natural reference element from the proteins on the spots.

Method:

The samples are 2 different serums from mouse; (A) and (B) wherein the proteins are labeled with fluorine.

Two arrays are prepared using a Spotbot 3 microarrayer (Array'it) with 8 spots on each array corresponding to 4 different antibodies in duplicate. Each spot correspond to a specific capture antibody.

The samples are put into contact with the arrays under conditions that allow the unlabeled grafted antibodies present on the spots to interact with the circulating molecules (protein targets) from the sample.

The four grafted antibodies are:

1. An antibody from rabbit against A, a signaling molecule of the immune system (known to have a good affinity but target present in low concentration in the serum)

2. Antibodies from rabbit against B, the constant fraction of a circulating antibody (unknown affinity)

3. Antibodies from goat against C, the constant fraction of a circulating antibody (known to a have good affinity)

4. Antibodies from goat against D, the whole circulating antibody (known to have a high affinity).

The array is washed and dryed. The analysis is done with a benchtop D-SIMS (MiniSIMS, SAI-Millbrook), by collecting the signals for the fluorine (mass 19) and the nitrogen (mass 26 for the secondary ions ¹²C¹⁴N).

Results:

FIG. 11 shows the imaged results of fluorine (ion ¹⁹F) distribution on the array, the distribution of the nitrogen (ion ¹²C¹⁴N) and the normalized image (F/CN). With this normalized image, we can perform a quantitative analysis shown in the table 3.

The image of fluorine is noisy and it is difficult to perform a quantitative analysis due to the low resolution and especially for spots with a low signal. In this case, the normalization increases the reliability of the result by decreasing the background signal and the noise around the spots.

TABLE 3

| | |
|---|---|
| Serum A (Array 1) | Serum B (Array 2) |

Signal for each spot before normalisation

| | | | | |
|---|---|---|---|---|
| Antibody 1 | 3.44^{E}5 | 7.23^{E}5 | 6.97^{E}5 | 9.34^{E}5 |
| Antibody 2 | 6.88^{E}5 | 1.23^{E}6 | 2.67^{E}6 | 5.97^{E}6 |
| Antibody 3 | 6.41^{E}5 | 5.40^{E}5 | 1.11^{E}6 | 9.88^{E}5 |
| Antibody 4 | 9.88E6 | 1.33E7 | 1.51E7 | 2.23E7 |

Signal for each spot after normalisation

| | | | | |
|---|---|---|---|---|
| Antibody 1 | 2258 | 3968 | 5631 | 5131 |
| Antibody 2 | 7841 | 9980 | 12718 | 14485 |
| Antibody 3 | 8800 | 6833 | 11295 | 11973 |
| Antibody 4 | 36538 | 33821 | 41506 | 40654 |

| Serum A | | | Serum B | | |
|---|---|---|---|---|---|
| Mean | SD | SD in % | Mean | SD | SD in % |

Before normalisation

| | | | | | | |
|---|---|---|---|---|---|---|
| Antibody 1 | 533500 | 267993,47 | 50% | 815500 | 167584,307 | 21% |
| Antibody 2 | 959000 | 383251,875 | 40% | 4320000 | 2333452,38 | 54% |
| Antibody 3 | 590500 | 71417,7849 | 12% | 1049000 | 86267,0273 | 8% |
| Antibody 4 | 11590000 | 2418305,19 | 21% | 18700000 | 5091168,82 | 27% |

After normalisation

| | | | | | | |
|---|---|---|---|---|---|---|
| Antibody 1 | 3113 | 1209,1526 | 39% | 5381 | 353,553391 | 7% |
| Antibody 2 | 8910,5 | 1512,5014 | 17% | 13601,5 | 1249,45768 | 9% |
| Antibody 3 | 7816,5 | 1390,87904 | 18% | 11634 | 479,418398 | 4% |
| Antibody 4 | 35179,5 | 1921,20912 | 5% | 41080 | 602,454978 | 1% |

Conclusions:

This experiment shows the ability to quantify proteins with the D-SIMS analysis of an array and the advantage of normalization with an element from the grafted molecules to increase the reliability of the signal.

1. Method for detecting and quantifying at least one type of target molecules by quantifying molecules-molecules interactions, comprising:
(a) grafting unlabelled molecules on one or more array(s),
(b) labelling with one or more exogenous element(s) one or more type(s) of circulating molecules in one or more solution(s);
(c) putting solution(s) containing circulating molecule(s) into contact with the one or more array(s) obtained from step (a), before or after the labelling step (b), under conditions that allow the unlabelled grafted molecules present on the array(s) to interact with the circulating molecules from the solution,
washing and drying the array,
(e) possibly locating the so-obtained spots,
(f) detecting and counting by D-SIMS said exogenous element(s) of each labelling or a group of elements containing said exogenous element(s) of each labelling and possibly a reference natural element present on the spot for each spot of each array,
(g) calculating the ratio(s) between spots of the values of the counting by D-SIMS of each labelling and/or calculating the ratio(s) for each spot between the value of the counting by D-SIMS of each labelling and the value of the counting by D-SIMS of a reference natural element present on the spot, for example in the grafted molecules or in the grafting buffer.

2. Method according to claim 1 in two solutions of at least one type of molecules, comprising the following steps in this order:
(a) grafting unlabelled molecules on one or more array(s),
(b1) labelling with an exogenous element X at least a type of circulating molecules in a solution 1;
(b2) labelling with an exogenous element Y different from X at least a type of circulating molecules in a solution 2 different from 1;
(c) putting said solutions 1 and 2 into contact with an array under conditions that allow the unlabelled grafted molecules present on the array to interact with the circulating molecules,
(d) washing and drying the array
(e) locating the so-obtained spots,
(f) detecting and counting by D-SIMS said exogenous elements X or a group of elements containing X and Y or a group of elements containing Y and/or a reference natural element present on the spot for each spot of each array.
(g) calculating the ratio(s) for each spot between the values of the counting by D-SIMS
of labellings X and Y of solutions 1 and 2,
and/or
of the reference natural element present on the spot and the labelling X of solution 1
and/or
of the reference natural element present on the spot and the labelling Y of solution 2.

3. Method according to claim 1 for detecting and quantifying in at least one solution of at least one type of circulating molecules, comprising the following steps in this order:
(a) grafting unlabelled molecules on one or more array(s),
(b1) labelling with an exogenous element X at least a type of circulating molecules in a part of a solution 1;
(b2) labelling with an exogenous element Y different from X the same type of circulating molecules in a part of a solution 2 different from 1;
(c1) putting said X-labelled solution 1 and Y-labelled solution 2 into contact with an array 3 under conditions that allow the unlabelled grafted molecules present on the array to interact with the circulating molecules,
(b3) labelling with an exogenous element Y at least a type of circulating molecules in a part of solution 1;
(b4) labelling with an exogenous element X the same type of circulating molecules in a part of solution 2;
(c2) putting said Y-labelled solution 1 and X-labelled solution 2 into contact with an array 4 identical with array 3 under conditions that allow the unlabelled grafted molecules present on the array to interact with the circulating molecules,
(d) washing and drying the arrays 3 and 4
(e) locating the so-obtained spots,
(f1) detecting and counting by D-SIMS said exogenous elements X or a group of elements containing X and Y or a group of elements containing Y for each spot of the array 3
(f2) detecting and counting by D-SIMS said exogenous elements X or a group of elements containing X and Y or a group of elements containing Y for each spot of the array 4
(g1) calculating the ratios X/Y for each spot between the values of the counting by D-SIMS of labellings X and Y for array 3
(g2) calculating the ratios X/Y for each spot between the values of the counting by D-SIMS of labellings X and Y for array 4
(h) comparing for each spot the results of the ratios obtained in steps (g1) and (g2).

4. Method according to claim 1 in two solutions of at least one type of molecules, comprising the following steps in this order:
(a) grafting unlabelled molecules on one or more array(s),
(b1) labelling with an exogenous element X at least a type of molecules in a solution 1;
(b2) labelling with an exogenous element Y different from X the same type of molecules in a solution 1;
(c1) putting said X-labelled solution 1 and Y-labelled solution 1 into contact with an array 3 under conditions that allow the unlabelled grafted molecules present on the array to interact with the circulating molecules,
(b3) labelling with an exogenous element Y at least a type of molecules in a solution 2;
(c2) putting said X-labelled solution 1 and Y-labelled solution 2 into contact with an array 4 identical with array 3 under conditions that allow the unlabelled grafted molecules present on the array to interact with the circulating molecules,
(d) washing and drying the arrays 3 and 4,
(e) locating the so-obtained spots,
(f1) detecting and counting by D-SIMS said exogenous elements X or a group of elements containing X and Y or a group of elements containing Y for each spot of the array 3,
(f2) detecting and counting by D-SIMS said exogenous elements X or a group of elements containing X and Y or a group of elements containing Y for each spot of the array 4,
(g1) calculating the ratios X/Y for each spot between the values of the counting by D-SIMS of labellings X and Y for array 3
(g2) calculating the ratios X/Y for each spot between the values of the counting by D-SIMS of labellings X and Y for array 4
(h) comparing for each spot the results of the ratios obtained in steps (g1) and (g2).

5. Method according to claim 1 for detecting at least one post-translational modification in a protein, comprising the following steps in this order:
(a) grafting unlabelled molecules on one or more array(s),
(b1) labelling with an exogenous element X proteins in a sampled solution 1;
(b2) labelling with an exogenous element Y different from X proteins in a sampled solution 1;
(c1) putting said X-labelled solution 1 and Y-labelled solution 1 into contact with an array 3 under conditions that allow the unlabelled grafted molecules present on the array to interact with the target proteins,
(c′1) putting into contact with array 3 an antibody or a lectin specific to the post-translational modification to be detected, said antibody or lectin being labelled with an exogenous element Z
(b3) labelling with an exogenous element Y proteins in a solution 2;
(c2) putting said X-labelled solution 1 and Y-labelled solution 2 into contact with an array 4 identical with array 3 under conditions that allow the unlabelled grafted molecules present on the array to interact with the target proteins,
(c′2) putting into contact with array 4 an antibody or lectin specific to the post-translational modification to be detected, said antibody or lectin being labelled with an exogenous element Z
(d) washing and drying the arrays 3 and 4
(e) locating the so-obtained spots,
(f1) detecting and counting by D-SIMS said exogenous element X or a group of elements containing X and Y or a group of elements containing Y and Z or a group of elements containing Z for each spot of the array 3
(f2) detecting and counting by D-SIMS said exogenous elements X or a group of elements containing X and Y or a group of elements containing Y and Z or a group of elements containing Z for each spot of the array 4
(g1) calculating the ratios X/Y, X/Z and Y/Z for each spot between the values of the counting by D-SIMS of labellings X, Y and Z for array 3
(g2) calculating the ratios X/Y, X/Z and Y/Z for each spot between the values of the counting by D-SIMS of labellings X, Y and Z for array 4
(h) comparing for each spot the results of the ratios obtained in steps (g1) and (g2).

6. Method according to claim 1 for several solutions using several circulating probes comprising the following steps in this order:
(a) spotting unlabelled molecules on one or more array(s),
(b1) labelling with an exogenous element X at least a type of circulating molecules
(b2) labelling with an exogenous element Y different from X another type of circulating molecules
(b3) labelling with an exogenous element Z different from X and Y another type of circulating molecules
(c1) putting said X-labelled, Y-labelled and Z-labelled circulating molecules in a solution
(c2) putting said X, Y and Z labelled probes solutions into contact with an array made of sampled molecules grafted on the support on spots, at least one spot for each sample to be tested, under conditions that allow the unlabelled sampled molecules grafted on the array to interact with the circulating labelled probes,
(d) washing and drying the array,
(e) locating the so-obtained spots,
(f) detecting and counting by D-SIMS said exogenous elements X or a group of elements containing X and said exogenous element Y or a group of elements containing Y and said exogenous element Z or a group of elements containing Z for each spot
(g) calculating the ratios X/Y, X/Z and Y/Z for each spot between the values of the counting by D-SIMS of labellings X, Y and Z.

7. Method according to any of the preceding claims, wherein the target molecules to be tested are the circulating molecules, and the probes are the grafted molecules.

8. Method according to any of the preceding claims, wherein the target molecules to be tested are the grafted molecules, and the probes are the circulating molecules.

9. Method according to any of the preceding claims, wherein said exogenous elements are selected in the group consisting of I, Br, F, S, Au, Fe, Se, As, P, B, Cu, Ag, Zn, Ni.

10. Method according to any of the preceding claims, wherein the circulating molecules are labelled by an exogenous element selected in the group consisting of I, Br, F.

11. Method according to any of the preceding claims, wherein the samples to be tested may be isolated from cells, tissue, organ, body fluid such as for instance sera, plasma, seminal fluid, synovial fluid, cerebrospinal fluid, blood or urine, a cell culture, a cell lysate, water such as sewage water, freshwater, marine coastal water, ground water or any solution containing biomolecules.

12. Method according to any of the preceding claims, wherein the molecules to be tested may comprise nucleic acids (oligonucleotides, DNA, RNA, PNA, Aptamers), peptides or proteins (antibodies, enzymes), lectins, ligands (an antigen, enzyme substrate, receptor or ligand for the receptor), glycans, lipids, polyamines, phages, viruses or a combination thereof.

13. Method of proteomic or genomic research according to any of the preceding claims, wherein several samples in the form of solution are screened in order to measure individual variations.

14. Method of diagnosis according to any of the preceding claims, wherein at least one solution is a reference sample and at least one solution is a potentially pathological sample.

15. Kit for diagnosis or proteomic or genomic research comprising array(s), probes and exogenous elements suitable for carrying out the method according to any of the preceding claims.
